(19) United States
(12) Patent Application Publication
(10) Pub. No.: US 2009/0280457 A1
(43) Pub. Date: Nov. 12, 2009

(54) CARD GAME FOR LEARNING AND PRACTICING FOREIGN LANGUAGES

(76) Inventor: Ron ELAZARI-VOLCANI, Rehovot (IL)

Correspondence Address: Ron ELAZARI-VOLCANI, 22 zukit street, P.O. Box 307, Ein-Sarid, 40697, IL

(21) Appl. No.: 12/118,719

(22) Filed: May 11, 2008

(51) Int. Cl. G09B 19/06; A63F 1/00; G09B 19/22

(52) U.S. Cl. 434/129; 273/302; 434/157

(57) ABSTRACT

A card game played with a deck of playing cards in a native language that are organized in thematic suits. Each player aims at having as many full suits as possible. Each player in turn asks other players for cards out of suits held by the player. The thematic suits comprise playing cards with expressions in at least one foreign language. Playing the game promotes the knowledge of the players of the foreign languages.

### FIELD OF THE INVENTION

The present invention generally relates to the field of games. More particularly, the present invention relates to an educational card game.

### BACKGROUND OF THE INVENTION

Card games appear in many different variants with changing rules and types of cards. There are card games such as Go Fish and Happy Families based on thematic suits, in which players collect cards to complete as many thematic suits as possible.

### SUMMARY OF THE INVENTION

The present invention discloses a card game played with a deck of playing cards in a native language organized in thematic suits. Each player aims at having as many full suits as possible. Each player in turn asks other players for cards out of suits held by the player. The thematic suits comprise playing cards with expressions in at least one foreign language, and playing the game promotes the knowledge of the players of the foreign languages.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a flowchart illustrating the playing of the card game, according to some embodiments of the invention.

FIG. 2 is an illustration of the players' cards during the card game, according to some embodiments of the invention.

FIG. 3 illustrates a way to represent a thematic suit of cards, according to some embodiments of the invention.

FIG. 4 illustrates another way to represent a thematic suit of cards, according to some embodiments of the invention.

FIG. 5 illustrates yet another way to represent a thematic suit of cards, according to some embodiments of the invention.

FIG. 6 illustrates the representation of a different thematic suit, according to some embodiments of the invention.

FIG. 7 illustrates the representation of yet a different thematic suit, according to some embodiments of the invention.

FIG. 8 illustrates the representation of four different languages in a thematic suit, according to some embodiments of the invention.

FIG. 9 illustrates the representation of sentences in four different languages in a thematic suit, according to some embodiments of the invention.

FIG. 10 illustrates a card comprising guiding questions that are typical to the card game in foreign languages, according to some embodiments of the invention.

### DETAILED DESCRIPTIONS OF SOME EMBODIMENTS OF THE INVENTION

The disclosed card game promotes the knowledge of the players in foreign languages. The card game is played with a deck organized in thematic suits. Each player aims at having as many full suits as possible. Each player in turn asks other players for cards out of suits held by the player. The thematic suits comprise expressions in at least one foreign language, and may comprise expressions in increasing difficulty such as nouns, verb, small sentences, and be with or without illustrations.

In the following, languages are denoted by the following abbreviations: En for English, He for Hebrew, Sp for Spanish, De for German, Ch for Chinese, Ru for Russian, Ar for Arabic. The shorthand Pro denotes the notation in the native language of the pronunciation of the expression in the foreign language. The word “expression” may denote any part of speech, as well as word combinations, sentences and illustrations. The following description assumes English as the native language of the card game, yet this usage may not be construed to limit the invention to English as a native language. Any other language may be used as a native language, and any language may be used as a foreign language.

The game is played with a deck containing suits of cards, the cards in each suit have a common theme and present expressions in different languages relating to the common theme. There are several variants of the playing rules. The essential feature is that each player at his/her turn asks another player if he/she has a card of a certain suit. If the other player does, it is handed to the asking player, who may continue asking the other players for cards. If the other player does not hold the requested card, the turn moves on to a different player. Players are allowed to ask for a card only if they hold a card from the same suit. The aim is to have as many full suits as possible.

Each deck may hold between 10-25 thematic suits of cards, each suit may hold between 3-5 cards. Each thematic suit holds cards with a common theme. Examples for themes are: nouns, body parts, vehicles, nature, driving terms, navigation, males, females, singular, plural, verbs, verb declination types, numbers, pronouns, adjectives, simple sentences, questions, daily life sentences, vacation destinations. The themes may be ordered in such a way, that a complete deck of cards may be used as a guide for every-day conversation. Every deck may include different thematic suits. Different decks may be at a different level of difficulty, e.g. simple decks may deal with vocabulary and simple grammar, more difficult decks may relate to sentence construction and decks at yet a higher level may comprise full daily life sentences.

The cards comprise of expressions in a native language and expressions in at least one foreign language. The expressions in the foreign language may be translations of the expressions in the native language. The cards may comprise a phonetic transcription of the expressions in the foreign language, based on the native language or on the International Phonetic Alphabet. The cards may comprise expressions in the foreign language and their phonetic transcription in the native language, without a translation to the native language itself. The cards may comprise several languages. The cards may further comprise visual objects illustrating the expressions they correspond to.

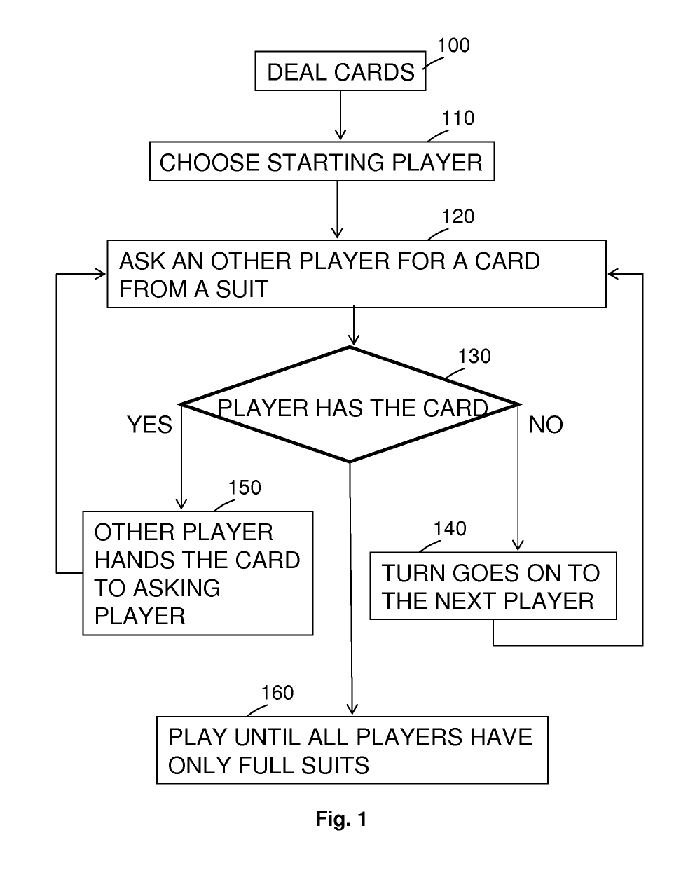

FIG. 1 is a flowchart illustrating the playing of the card game, according to some embodiments of the invention. The cards are dealt to the players (step 100) and the starting player is chosen (step 110). All cards may be dealt to the players, or a pack may be left in the middle for later drawings. The turn moves among the player in a pre-established order. The player in turn asks an other player for a card (step 120) from a suit the asking player already has a representative of. If the other player has the card (step 130), the other player hands the card to the asking player (step 150), and the asking player continues (step 120). If the other player does not have the card (step 130), the turn goes on to the next player (step 140). The game ends when all players have full suits only (step 160). The aim is to get hold of as many suits as possible, and the winner is the player with most suits.

According to some embodiments of the invention, players ask for cards from a suit they have members of, and not for a specific card (e.g. “do you have furniture?” instead of “do you have a table?”). In case of a false guess (steps 130, 140), the asking player may have to take a card from the pack left in the middle for later drawings.

According to some embodiments of the invention, the card game may be used in a method for learning a foreign language by using cards comprising expressions in a native language and expressions in at least one foreign language. The expressions in the foreign language may be translations of expressions in the native language. Furthermore, the asking of players for cards (step 120) may be carried out in the foreign language. Additional cards with guiding questions in the foreign language that are typical to the card game may used to enhance the practicing of the foreign language. In some embodiments of the invention, players may use a notation in the native language of the pronunciation of the expressions in the foreign language to enhance active language abilities. Sentences and questions may be presented in versions corresponding to the player's gender. Expressions in female, male or neutral language may be marked in different colors upon the cards.

The card game may have a version based upon a computerized medium such as a website, or CD. The computerized version may allow the players to visualize the expressions on the card, or help the players pronounce the expression and understand the meaning of the expressions. The card game may be played as a web based game among several players at different places. The cards may be exchanged for gadgets that may communicate electronically and vocalize the expressions.

According to some embodiments of the invention, the card game may be used in a method for learning idioms in a foreign language by using cards comprising explanations in a native language for idioms in at least one foreign language, or similar idioms in different languages.

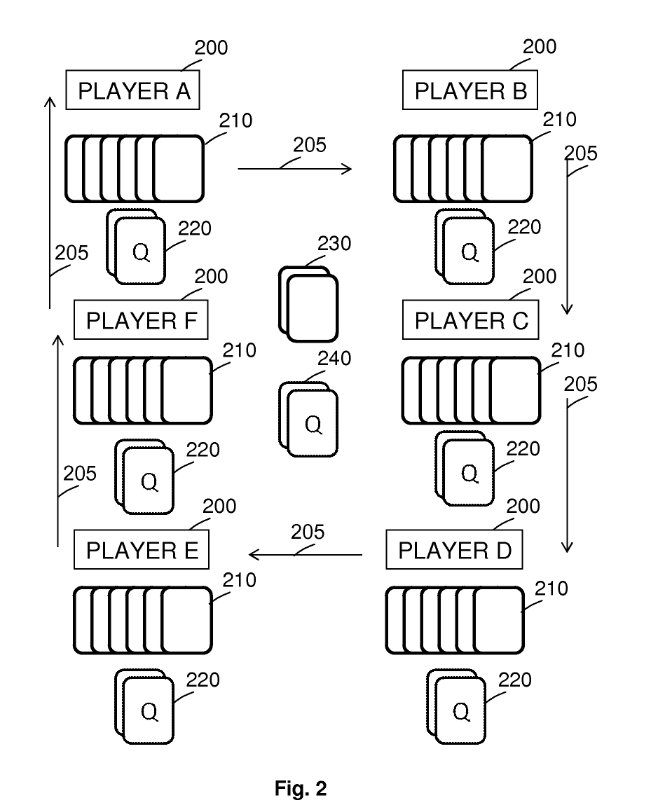

FIG. 2 is an illustration of the players' cards during the card game, according to some embodiments of the invention. In this figure, six players (A-F, 200) participate in the card game. Each player 200 holds cards from suits (210) and language cards 220 that may be similar for different players 200. A pack of cards that were not yet dealt (230) is in the middle, as well as a pack of language cards 240. The language cards 220 may comprise common guiding questions used in the card game in the foreign language, thus enabling playing using the foreign language. The arrows 205 denote the direction the turn moves among players 200.

According to some embodiments of the invention, the language cards 220 may comprise alternative guiding questions for the same purpose, e.g. “give me card X, please”, “do you hold card X”. The language cards 220 may also hold answer cards for answering the guiding questions, such as “I have the card X”, “no luck this time, mate”. According to some embodiments of the invention, some of the thematic suits may be such questions and answers—either as different questions and answers in a suit, or as parts of complete sentences in a suit. Additional expressions related to the game and its environment may be: “Can you bring some beverages?”, “can you bring me some potato chips, please?”, “I won”, “Your turn”, “My turn” “I have three suits”, etc.

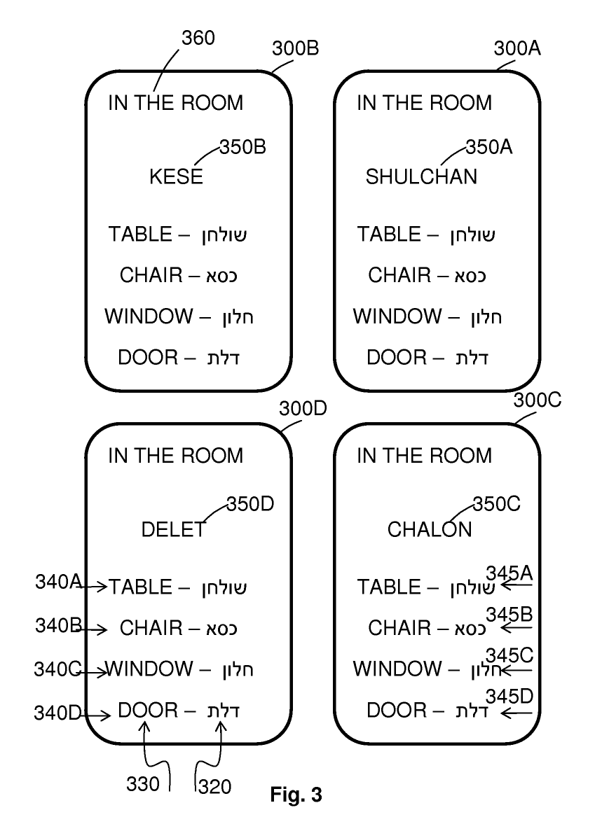

FIG. 3 illustrates a way to represent a thematic suit of cards, according to some embodiments of the invention. The thematic suit “in the room” is marked by its theme 360, and comprises cards 300A, 300B, 300C, 300D. Each card 300 comprises expressions in the native language 330 and expressions in the foreign language 320. The expressions are ordered in pairs and relate to the common theme: Table (En 340A, He 345A), chair (En 340B, He 345B), window (En 340C, He 345C), door (En 340D, He 345D). Each of the cards also has a notation in the native language of the pronunciation of one of the expressions in the foreign language. In the embodiment exemplified in FIG. 3, shulchan 350A is the pronunciation of the Hebrew expression for table, Kese 350B is the pronunciation of the Hebrew expression for chair, chalon 350C is the pronunciation of the Hebrew expression for window, and delet 350D is the pronunciation of the Hebrew expression for door.

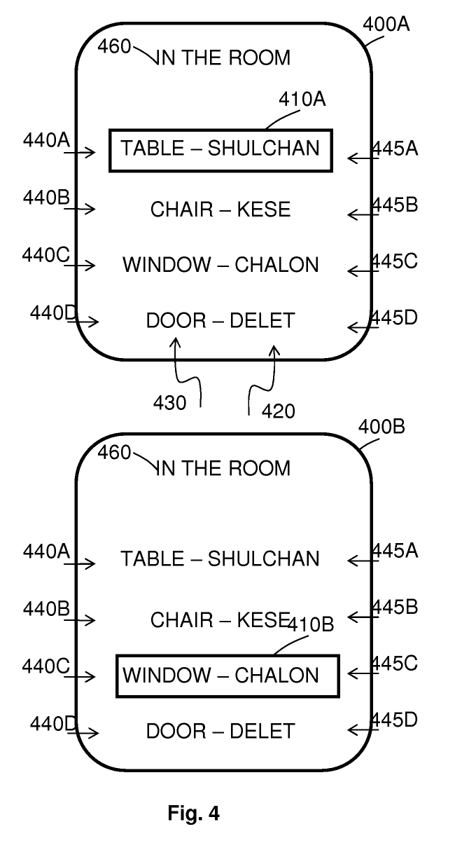

FIG. 4 illustrates another way to represent a thematic suit of cards, according to some embodiments of the invention. A different embodiment of the thematic suit “in the room” is marked by its theme 460 and comprises cards 400A and 400B as representatives of the full suit. According to this embodiment, expressions in the native language 430 are paired with the notation in the native language of the pronunciation of the expression in the foreign language 420. So, Table 440A corresponds to shulchan 445A (the pronunciation of the Hebrew expression for table), chair 440B corresponds to kese 445B (the pronunciation of the Hebrew expression for chair), window 440C corresponds to chalon 445C (the pronunciation of the Hebrew expression for window), and door 440D corresponds to delet 445D (the pronunciation of the Hebrew expression for door). Each of the cards corresponds to one of the pairs, which is marked upon the card (410A, 410B).

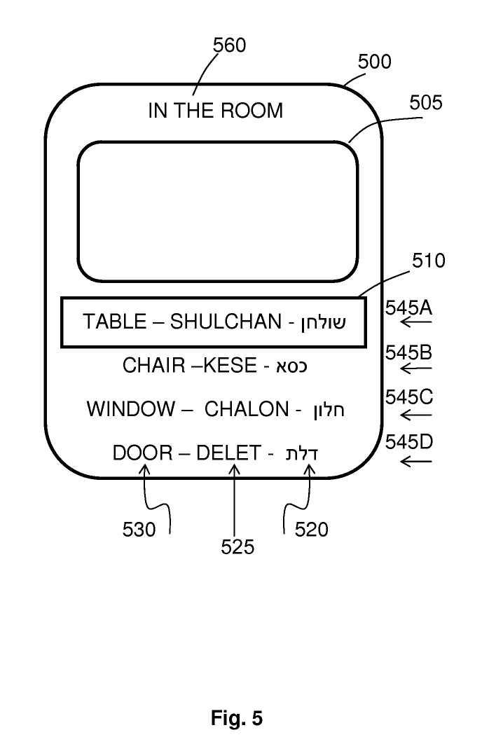

FIG. 5 illustrates yet another way to represent a thematic suit of cards, according to some embodiments of the invention. In this embodiment, on each card 500 the thematic suit “in the room” is marked by its theme 560. The expressions 545A, 545B, 545C, 545D are represented in all three options: the native language 530, the foreign language 520 and the notation in the native language of the pronunciation of the expression in the foreign language 525. Each of the cards corresponds to one of the expressions, which is marked upon the card (510). In addition a visual object 505 illustrating the expressions may appear on the card. The relevant expression in each card may be marked in the visual object 505.

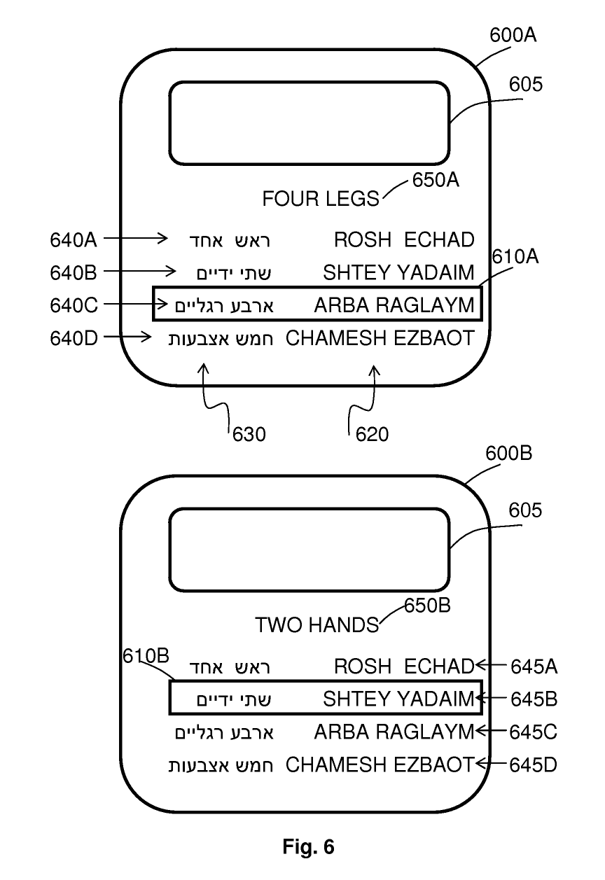

FIG. 6 illustrates the representation of a different thematic suit, according to some embodiments of the invention. In this embodiment, the theme is body parts and their number. Two cards 600A, 600B are presented as an example. Each expression is presented in the foreign language 630 and in the notation in the native language of the pronunciation of the expression in the foreign language 620. In this example the expressions are one head (He 640A, Pro 645A), two hands (He 640B, Pro 645B), four legs (He 640C, Pro 645C), five fingers (He 640D, Pro 645D). The expression in English 650A, 650B is presented in addition and differently on each card of the suit, and the expression is also marked 610A, 610B correspondingly on each card. A visual object 605 may include figures of the expressions, or only the numbers of the expressions.

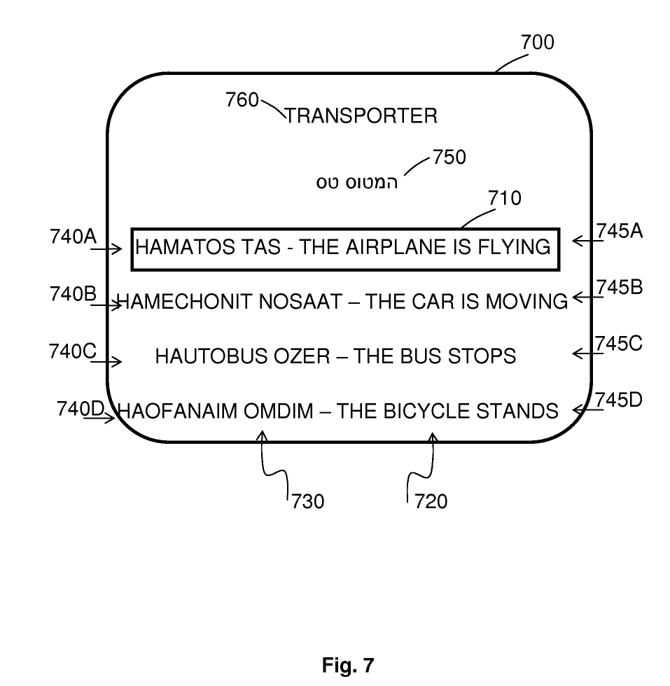

FIG. 7 illustrates the representation of yet a different thematic suit, according to some embodiments of the invention. In this example, the theme is transport 760, and the expressions are short sentences describing different vehicles and their movements. The expressions are represented as the notation in the native language of the pronunciation of the expression in the foreign language 730 and in the native language 720. The sentences are: The airplane is flying (Pro 740A, En 745A), the car is moving (Pro 740B, En 745B), the bus stops (Pro 740C, En 745C), the bicycle stands (Pro 740D, En 745D). The cards in the suit differ in the marked sentence 710 which is also represented in the foreign language 750.

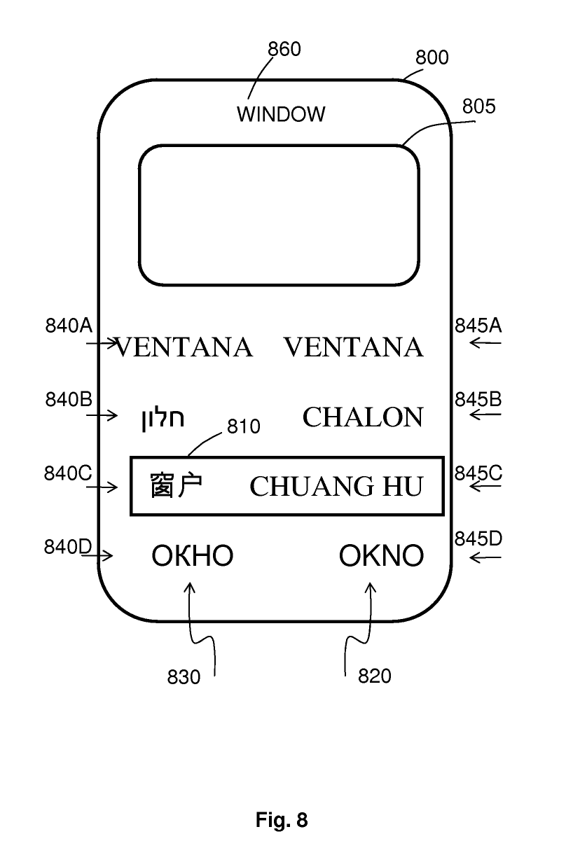

FIG. 8 illustrates the representation of four different languages in a thematic suit, according to some embodiments of the invention. The theme of the card 800 here is a window 860, presented in four different languages. In each language, the expression is presented in the language 830 and as the notation in the native language of the pronunciation of the expression in the foreign language 820. In this example the languages are Spanish (Sp 840A, Pro 845A), Hebrew (He 840B, Pro 845B), Chinese (Ch 840C, Pro 845C), Russian (Ru 840D, Pro 845D). On each card of the thematic suit another pair of expressions is framed 810. A visual object 805 illustrating the expression (in this case a window) may be included upon the card 800. Expressions on the cards may be written in the native alphabet, in a foreign alphabet or in several a foreign alphabets

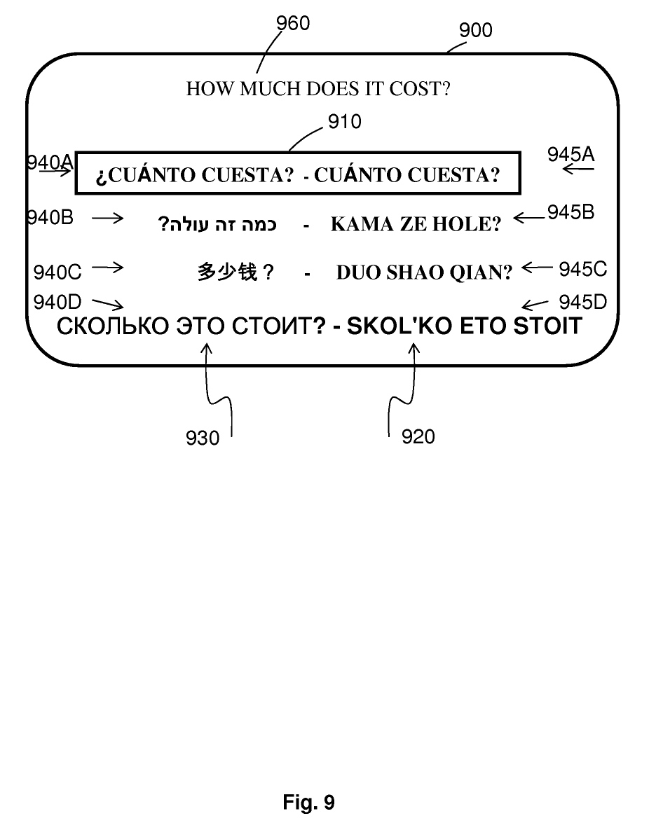

FIG. 9 illustrates the representation of sentences in four different languages in a thematic suit, according to some embodiments of the invention. The theme of the card 900 is the guiding question “how much does it cost?” 960, presented in four foreign languages. In each foreign language, the expression is presented in the foreign language 930 and as the notation in the native language of the pronunciation of the expression in the foreign language 920. In this example the languages are Spanish (Sp 940A, Pro 945A), Hebrew (He 940B, Pro 945B), Chinese (Ch 940C, Pro 945C), Russian (Ru 940D, Pro 945D). On each card of the thematic suit another sentence is framed 910.

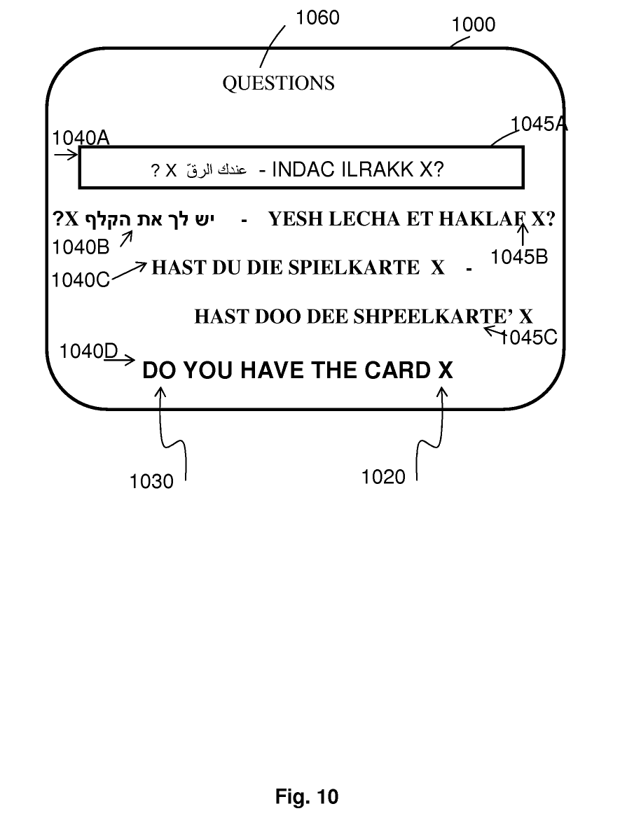

FIG. 10 illustrates a card comprising guiding questions that are typical to the card game in foreign languages, according to some embodiments of the invention. The card 1000 is denoted as a “guiding questions” 1060 card, and in the example comprises the guiding question “Do you have the card X”—in the foreign languages 1030 and as the notation in the native language of the pronunciation of the expression in the foreign language 1020. In this example the languages are Arabic (Ar 1040A, Pro 1045A), Hebrew (He 1040B, Pro 1045B), German (De 1040C, Pro 1045C), and English 1040D as the native language. The cards with guiding questions may have a different color than the other cards.

According to some embodiments of the invention, speech producing integrated circuits may be attached to the cards that may reproduce the pronunciation of the expressions on the cards in different languages. The player may control the language of speech reproduction. The cards may further comprise speech recognizing integrated circuits for feedbacking the players regarding their pronunciation. A computerized medium may hold all expression on all cards in all languages and may be used by the players to enhance learning. The computerized medium may be a CD, a webpage or an element attached to the box containing the card game. Additional cards may be added, which contain speech producing integrated circuits that may reproduce the pronunciation of the expressions on all cards.

According to some embodiments of the invention, cards with the foreign alphabets and their pronunciation may be added. These cards may be appended to the instructions of the game, or be given to each player to help with pronouncing words in the foreign languages used in the game.

In the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. In a card game played with a deck of playing cards, wherein said deck comprising a plurality of thematic suits of playing cards with expressions in a native language, wherein each player aims at having as many full suits as possible, and wherein each player in turn asks other players for cards out of suits held by said player,
said thematic suits comprise playing cards with expressions in at least one foreign language, and playing the game promotes the knowledge of the players in said least one foreign language.

2. The card game of claim 1, wherein said expressions in at least one foreign language are a translation of said expressions in a native language.

3. The card game of claim 1, wherein each card further comprises at least one visual object related to the at least one expression on the card.

4. The card game of claim 1, wherein each card comprises all the expressions of a thematic suit, and wherein a different expression is marked in each card of said thematic suit.

5. The card game of claim 1, further comprising at least one card with guiding questions that are typical to said card game, wherein said guiding questions are in the foreign language.

6. The card game of claim 1, wherein each card comprises a notation in the native language of the pronunciation of the at least one expression in said at least one foreign language.

7. The card game of claim 1, wherein expressions in female, male or neutral language are marked in different colors upon the cards.

8. A method for learning a foreign language by playing a card game using a deck of cards comprising a plurality of thematic suits of playing cards with expressions in a native language, wherein playing said card game comprises the steps:
dealing said cards to a plurality of players,
asking other players for cards of a thematic suit,
getting hold of as many suits as possible;
said method comprising using cards comprising expressions in at least one foreign language.

9. The method of claim 8, wherein said expressions in at least one foreign language are a translation of said expressions in a native language.

10. The method of claim 8, wherein said cards further comprise at least one visual object related to said expressions.

11. The method of claim 8, wherein said asking other players for cards is carried out in at least one foreign language.

12. The method of claim 8, further comprising using at least one card with guiding questions that are typical to said card game, wherein said guiding questions are in said at least one foreign language.

13. The method of claim 8, wherein the notation in the native language of the pronunciation of the expression in the foreign language is utilized to enhance active language abilities.
